(19) United States
(12) Patent Application Publication
(10) Pub. No.: US 2013/0088748 A1
(43) Pub. Date: Apr. 11, 2013

(54) IMAGE FORMING APPARATUS, IMAGE FORMING SYSTEM, AND NON-TRANSITORY COMPUTER READABLE MEDIUM

(71) Applicants: Atsushi MIKAMI, Kanagawa (JP); Hideharu SAKAKIBARA, Kanagawa (JP); Koujirou OISHI, Kanagawa (JP); Nobuyuki KUTOH, Kanagawa (JP); Tooru TAKAHASHI, Kanagawa (JP)

(72) Inventors: Atsushi MIKAMI, Kanagawa (JP); Hideharu SAKAKIBARA, Kanagawa (JP); Koujirou OISHI, Kanagawa (JP); Nobuyuki KUTOH, Kanagawa (JP); Tooru TAKAHASHI, Kanagawa (JP)

(73) Assignee: FUJI XEROX CO., LTD., Tokyo (JP)

(21) Appl. No.: 13/483,834

(22) Filed: May 30, 2012

(30) Foreign Application Priority Data
Oct. 6, 2011 (JP) 2011-221644

(51) Int. Cl. G06F 3/12; G06K 15/02

(52) U.S. Cl. 358/1.15

(57) ABSTRACT

An image forming apparatus includes an image data memory, a transmitting unit, a receiving unit, an edit information converting unit, and an image editing unit. The image data memory stores image data. The transmitting unit transmits related image data related to the image data to an external terminal apparatus. The receiving unit receives first edit information from the external terminal apparatus, the first edit information representing details of edit that has been performed on the related image data. The edit information converting unit converts the first edit information to generate second edit information, the second edit information representing details of edit that is to be performed on the image data. The image editing unit edits the image data by using the second edit information.

### CROSS-REFERENCE TO RELATED APPLICATIONS

This application is based on and claims priority under 35 USC 119 from Japanese Patent Application No. 2011-221644 filed Oct. 6, 2011.

### BACKGROUND

(i) Technical Field

The present invention relates to an image forming apparatus, an image forming system, and a non-transitory computer readable medium.

(ii) Related Art

An image forming apparatus having a scanner function of obtaining image data from a printed material is known. Image data obtained by using the scanner function is downloaded from the image forming apparatus to a terminal apparatus, such as a personal computer, via a communication medium, such as a local area network (LAN). In a case where the image forming apparatus prints processed image data, the terminal apparatus edits the image data and transmits the edited image data to the image forming apparatus.

### SUMMARY

According to an aspect of the invention, there is provided an image forming apparatus including an image data memory, a transmitting unit, a receiving unit, an edit information converting unit, and an image editing unit. The image data memory stores image data. The transmitting unit transmits related image data related to the image data to an external terminal apparatus. The receiving unit receives first edit information from the external terminal apparatus, the first edit information representing details of edit that has been performed on the related image data. The edit information converting unit converts the first edit information to generate second edit information, the second edit information representing details of edit that is to be performed on the image data. The image editing unit edits the image data by using the second edit information.

### BRIEF DESCRIPTION OF THE DRAWINGS

Exemplary embodiments of the present invention will be described in detail based on the following figures, wherein:

FIG. 1 is a configuration diagram of an image forming system according to an exemplary embodiment;

FIG. 2 is a functional configuration diagram of an image forming apparatus according to the exemplary embodiment;

FIG. 3 is a configuration diagram of functions of a CPU of the image forming apparatus and data stored in an HDD according to the exemplary embodiment;

FIG. 4 is a functional configuration diagram regarding a reduced image transmission process according to the exemplary embodiment;

FIG. 5 is a functional configuration diagram regarding an edit information generation process according to the exemplary embodiment;

FIG. 6 is a functional configuration diagram regarding edited image processing according to the exemplary embodiment;

FIG. 7 is a functional configuration diagram of a terminal apparatus according to the exemplary embodiment;

FIG. 8 is a configuration diagram of functions of a CPU of the terminal apparatus according to the exemplary embodiment;

FIG. 9 is a ladder chart illustrating communication between the image forming apparatus and the terminal apparatus according to the exemplary embodiment;

FIG. 10 is a flowchart illustrating a reduced image transmission process according to the exemplary embodiment;

FIG. 11 is a flowchart illustrating an edit information generating process according to the exemplary embodiment;

FIG. 12 illustrates a process of converting edit information according to the exemplary embodiment;

FIG. 13 is a flowchart illustrating edited image processing according to the exemplary embodiment;

FIG. 14 is a flowchart illustrating a process performed by the CPU of the terminal apparatus according to the exemplary embodiment;

FIG. 15 illustrates an example of an image selection screen displayed on the terminal apparatus according to the exemplary embodiment;

FIG. 16 illustrates an example of a reduced image edit screen (before edit) displayed on the terminal apparatus according to the exemplary embodiment;

FIG. 17 illustrates an example of an image output destination selection screen displayed on the terminal apparatus according to the exemplary embodiment;

FIG. 18 illustrates an example of an edit operation in the terminal apparatus according to the exemplary embodiment;

FIG. 19 illustrates an example of editing a reduced image in the terminal apparatus according to the exemplary embodiment;

FIG. 20 illustrates an image edit process according to the exemplary embodiment;

FIG. 21 illustrates another example of editing a reduced image in the terminal apparatus according to the exemplary embodiment;

FIG. 22 illustrates an example of a partially enlarged display of an image according to the exemplary embodiment;

FIG. 23 illustrates an example of a partially enlarged display of an image according to another exemplary embodiment;

FIG. 24 is a flowchart illustrating a process performed by the CPU of the image forming apparatus according to the other exemplary embodiment;

FIG. 25 is a flowchart illustrating a process performed by the CPU of the terminal apparatus according to the other exemplary embodiment;

FIG. 26 is a ladder chart illustrating communication between the image forming apparatus and the terminal apparatus according to still another exemplary embodiment;

FIG. 27 is a flowchart illustrating a process performed by the CPU of the terminal apparatus according to the still another exemplary embodiment; and

FIG. 28 is a flowchart illustrating an edit information generation process according to the still another exemplary embodiment.

### DETAILED DESCRIPTION

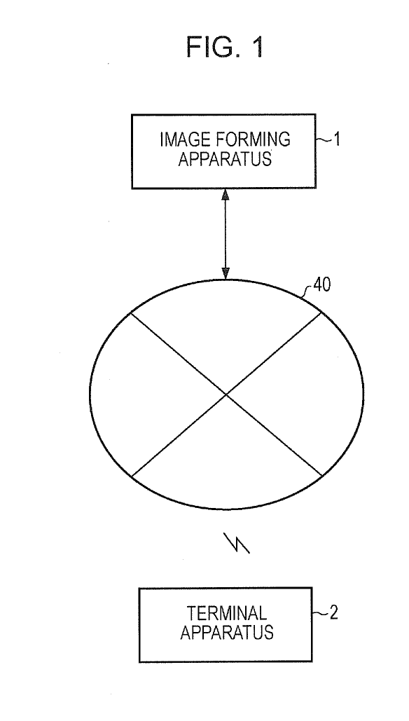

As illustrated in FIG. 1, an image forming system according to an exemplary embodiment includes an image forming apparatus 1 and a terminal apparatus 2. The image forming apparatus 1 is an apparatus that provides a user with a copy function, a print function, a scan function, and a fax function.

The terminal apparatus 2 is a mobile terminal apparatus, such as a mobile phone or a smart phone, and includes a wireless communication unit. The image forming apparatus 1 and the terminal apparatus 2 are capable of communicating with each other via, for example, a local area network (LAN) 40. The communication medium used by the image forming apparatus 1 and the terminal apparatus 2 is not limited to the LAN 40. For example, Bluetooth (registered trademark) may be used. The terminal apparatus 2 is not limited to the above-described apparatuses including a wireless communication unit, and may be another type of apparatus, such as a personal computer including a LAN port.

In this exemplary embodiment, the image forming apparatus 1 reduces image data obtained by scanning a printed material to generate reduced image data, and transmits the reduced image data to the terminal apparatus 2 via the LAN 40, in response to a request from the terminal apparatus 2. Here, the printed material is a document, photograph, figure, or drawing which is printed on a sheet of paper or the like.

The terminal apparatus 2 receives the reduced image data, edits the reduced image data, and transmits edit information representing the details of the edit to the image forming apparatus 1. The edit information is not the edited reduced image data, but represents, for example, the type and position of a mark, character string, or line segment added to the reduced image data in an edit operation. The image forming apparatus 1 edits the image data by using the received edit information, and performs a printing process or the like on the edited image data.

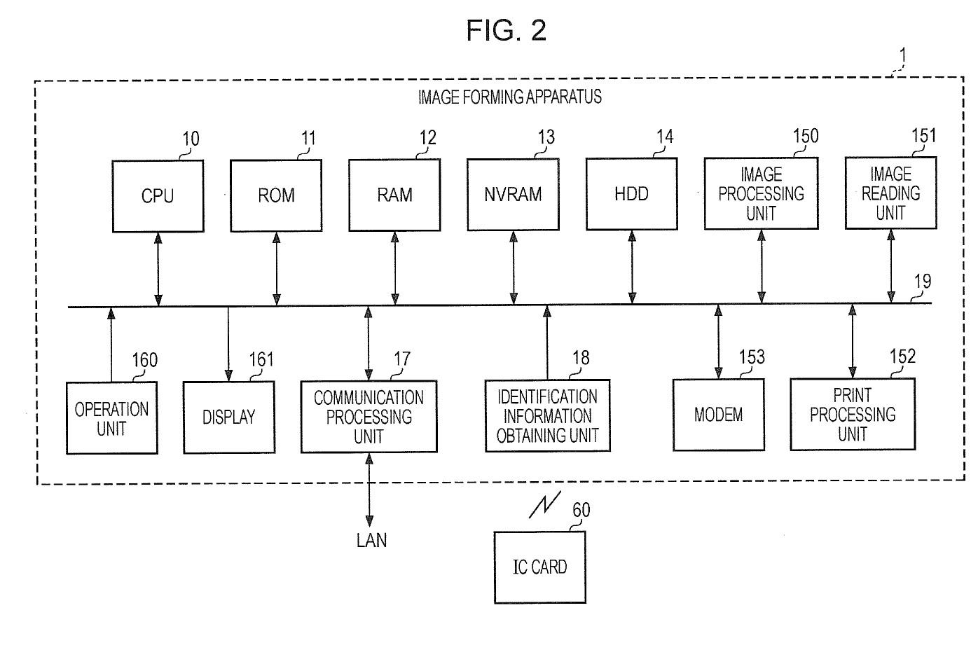

The functions of the image forming apparatus 1 will be described with reference to FIG. 2. The image forming apparatus 1 includes a central processing unit (CPU) 10, a read only memory (ROM) 11, a random access memory (RAM) 12, a nonvolatile memory (nonvolatile RAM (NVRAM)) 13, an operation unit 160, a display 161, and a communication processing unit 17.

The CPU 10 is a processing circuit that controls the entire image forming apparatus 1. For example, the CPU 10 executes the scan function and the print function, generates image data, and edits image data. The ROM 11 stores a program for operating the CPU 10. The RAM 12 is a working memory with which the CPU 10 operates in accordance with the program. The image forming apparatus 1 according to this exemplary embodiment is configured so as to be operated by software, but may be configured by hardware including an application-specific integrated circuit (ASIC) or the like.

The nonvolatile memory 13 is a flash memory, for example, and stores a user management table containing identification information for identifying a user, parameters regarding the operation setting of the apparatus, and so forth. Here, a user is a person who uses the image forming apparatus 1.

The operation unit 160 is an operation unit with which the user of the image forming apparatus 1 performs various operations, and includes a touch panel and a hard key. Specifically, the operation unit 160 is used as an instruction unit for providing an instruction to execute the scan function or the like, and as an input unit for inputting information, such as user identification information. The display 161 is a liquid crystal panel, for example, and is used together with the foregoing touch panel superimposed on the liquid crystal panel. The display 161 is used as a display unit for displaying image data, an input screen of the touch panel, and so forth.

The communication processing unit 17 is a communication unit that communicates with an external apparatus, is connected to the LAN 40, and includes a circuit for processing communication with another apparatus.

Also, the image forming apparatus 1 includes an identification information obtaining unit 18, a hard disk drive (HDD) 14, an image processing unit 150, an image reading unit 151, a modem 153, and a print processing unit 152.

The identification information obtaining unit 18 functions, in conjunction with the operation unit 160, as an identification information input unit for inputting identification information for identifying a user. For example, the identification information obtaining unit 18 is constituted by an IC card reader that reads an identification number from an IC card 60 of a user by using near field communication (NFC). The identification information obtaining unit 18 is connected to the body of the image forming apparatus 1 via a universal serial bus (USB) interface or the like.

An example of identification information may be an identification number, which is a unique number assigned to a user. The identification information is not limited to an identification number, and may be a character string including characters, such as alphabetical characters.

In the case of using the image forming apparatus 1, the user holds the IC card 60 over the identification information obtaining unit 18 so as to cause the image forming apparatus 1 to recognize the identification number, or directly inputs the identification number by using the operation unit 160. The obtained identification number is compared with the identification number in the user management table stored in the nonvolatile memory 13, so that user authentication is performed. After the user has been authenticated, the user is capable of using the scan function and so forth of the image forming apparatus 1. The identification information obtaining unit 18 may be constituted by a device other than an IC card reader as long as the device functions as an obtaining unit that obtains identification information. For example, a device that reads identification information from a magnetic card of a user or from the terminal apparatus 2 may be employed.

The HDD 14 is a storage unit that stores image data generated by using the scan function, edit information regarding image data, and so forth. The image processing unit 150 compresses and decompresses image data.

The image reading unit 151 functions as an image data generating unit that scans a printed material and generates image data. For example, the image reading unit 151 causes a printed material to be irradiated with light, and receives reflected light by using a charge-coupled device (CCD), thereby generating image data.

The modem 153 is connected to a telephone line when the fax function is executed, so as to perform fax communication. The print processing unit 152 prints image data or the like when the print function is executed.

The above-described CPU 10, ROM 11, RAM 12, NVRAM 13, HDD 14, image processing unit 150, image reading unit 151, print processing unit 152, modem 153, operation unit 160, display 161, communication processing unit 17, and identification information obtaining unit 18 are electrically connected to one another via a bus 19.

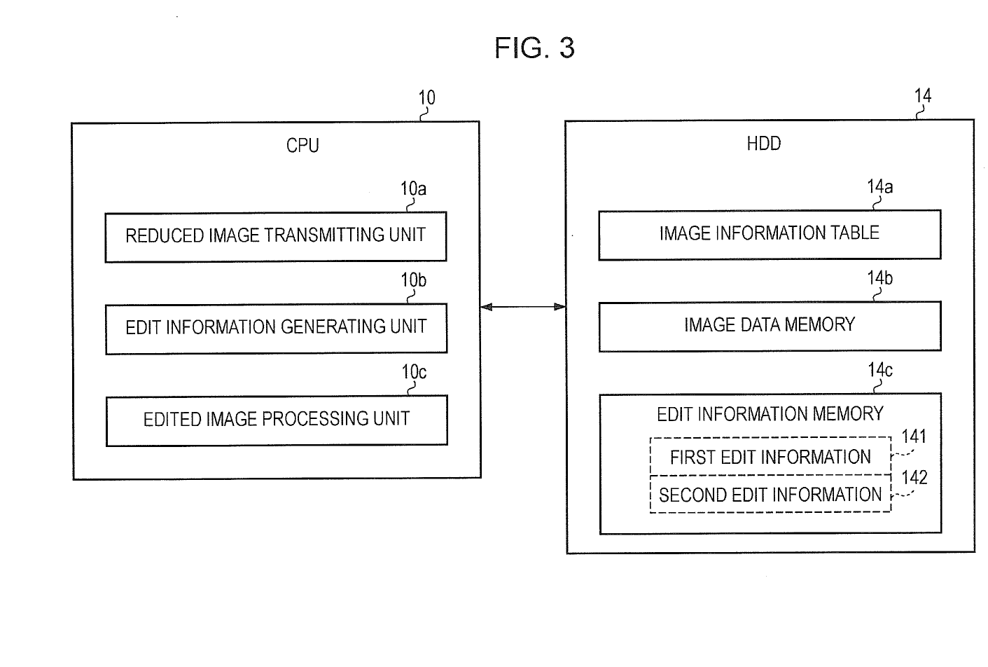

Next, the functions of the CPU 10 will be described with reference to FIG. 3. Upon reading a program stored in the ROM 11, the CPU 10 functions as a reduced image transmitting unit 10a, an edit information generating unit 10b, and an edited image processing unit 10c.

The reduced image transmitting unit 10a transmits, in response to a request from the terminal apparatus 2, reduced image data which is obtained by reducing image data to the terminal apparatus 2 via the communication processing unit 17. The edit information generating unit 10b converts first edit information received from the terminal apparatus 2, thereby generating second edit information that is to be used for the original image data. The edited image processing unit 10c edits the image data by using the second edit information and performs an output process such as printing thereon, in response to a request from the terminal apparatus 2.

The reduced image transmitting unit 10a, the edit information generating unit 10b, and the edited image processing unit 10c of the CPU 10 execute a process in accordance with the data stored in the HDD 14. The HDD 14 includes an image information table 14a, an image data memory 14b, and an edit information memory 14c.

TABLE 1

| Image ID | | User ID | | Edit info ID |
|---|---|---|---|---|
| No. | File name | No. | Edit | No. |
| 1108101156 | IMAGE_1108101156 | 00002011 | Editable | 1108101156 |
| 1108101503 | IMAGE_1108101503 | 00001388 | Editable | 1108101503 |
| 1108101506 | IMAGE_1108101506 | 00001388 | Not- | 1108101506 |
| | | | editable | |
| 1108101613 | IMAGE_1108101613 | 00001585 | Editable | 1108101613 |
| 1108101615 | IMAGE_1108101615 | 00001388 | Editable | 1108101615 |
| 1108110852 | IMAGE_1108110852 | 00001388 | Editable | 1108110852 |
| 1108111023 | IMAGE_1108111023 | 00002011 | Editable | 1108111023 |

As shown in table 1, the image information table 14a is a record of management information corresponding to each piece of image data generated by using the scan function. In table 1, “Image ID No.” is a unique number for identifying each piece of image data, and specifies one of plural pieces of image data stored in the image data memory 14b.

“File name” is a file name assigned to each piece of image data. A file name may include, for example, a character string and numerical information representing the year, month, and date when the piece of image data was generated. “File name” is not limited thereto, and may be specified by a user by using the operation unit 160. The extension of a file name, which is not shown in table 1, may be “.jpg”, for example. In table 1, the numbers included in “Image ID No.” and the numbers included in “File name” are identical to each other, but may be different from each other.

“User ID No.” is an identification number that is input by a user by using the identification information obtaining unit 18 or the operation unit 160 before using the image forming apparatus 1, as described above. That is, “User ID No.” is information for specifying the user who has generated image data.

“Edit” is information representing whether or not image data is editable. The information is set by a user by using the operation unit 160 before executing the scan function, and is written in a header portion of the image data. As a result of setting “Edit” information to highly confidential image data, the image data is prevented from being modified.

“Edit info ID No.” is a number for identifying a piece of edit information regarding image data and reduced image data corresponding to the image data. “Edit info ID No.” specifies one of plural pieces of edit information stored in the edit information memory 14c. In table 1, the numbers included in “Image ID No.” and the numbers included in “Edit info ID No.” are identical to each other, but may be different from each other.

Each piece of edit information includes first edit information 141 representing the details of edit performed on reduced image data, and second edit information 142 representing the details of edit to be performed on image data. The first edit information 141 is generated through an edit operation in the terminal apparatus 2 and is transmitted to the image forming apparatus 1. On the other hand, the second edit information 142 is generated on the basis of the first edit information 141 through a conversion process performed by the edit information generating unit 10b.

TABLE 2

| Edit type | | |
|---|---|---|
| code | Edit command | Parameters |
| 001 | Marking | Image code, Position, Size, Color |
| 002 | Straight line | Line type code, Start position, |
| | | End position, Thickness, Color |
| 003 | Character | Character code, Head position, |
| | string | Size, Color, Font type code |
| 004 | Cut out | two diagonal vertex positions |

Each of the first edit information 141 and the second edit information 142 includes an edit type code and parameters shown in table 2. The edit type code is a unique number assigned to each edit command in table 2. As shown in table 2, examples of the edit command include a command for adding a mark, such as “confidential”, a straight line, or a character string to an image, and a command for cutting out a rectangular region of an image. Examples of the edit command are not limited to those described above, and may include another example.

Parameters are information associated with an edit command, and vary depending on an edit command. For example, the parameters of “Marking” include an image code indicating the type of mark (confidential, urgent, etc.), and the position, size, and color of the mark. The parameters of “Straight line” include a line type code indicating the type of line, such as a solid line or a broken line, and the start position, end position, thickness, and color of the line.

The parameters of “Character string” include a character code of each character, such as a Japanese Industrial Standards (JIS) code or an American Standard Code for Information Interchange (ASCII) code, the head position of a character string, the size and color of characters, and a font type code representing Gothic, Mincho, or the like. The parameters of “Cut out” include two diagonal vertex positions of a cut out rectangular region. The parameters are not limited thereto, and the parameters of “Cut out” may include one vertex position, and the vertical and horizontal lengths of the rectangular region.

Each of the first edit information 141 and the second edit information 142 includes one or more edit type codes and the parameters corresponding thereto in accordance with the details of edit performed on a reduced image. When the “Cut out” command is used, a cut out rectangular region is regarded as an edited image, and thus two or more “Cut out” commands are not included in a single piece of first edit information 141 and second edit information 142. In contrast, the other commands do not have such restrictions, and thus two or more same edit type codes may be included in a single piece of first edit information 141 and second edit information 142.

As described above, the first edit information 141 represents the details of edit performed on reduced image data that has been transmitted to the terminal apparatus 2, and the second edit information 142 represents the details of edit to be performed on original image data. Therefore, the first edit information 141 and the second edit information 142 include the same edit type code, but the parameters regarding the position and size included therein are different from each other.

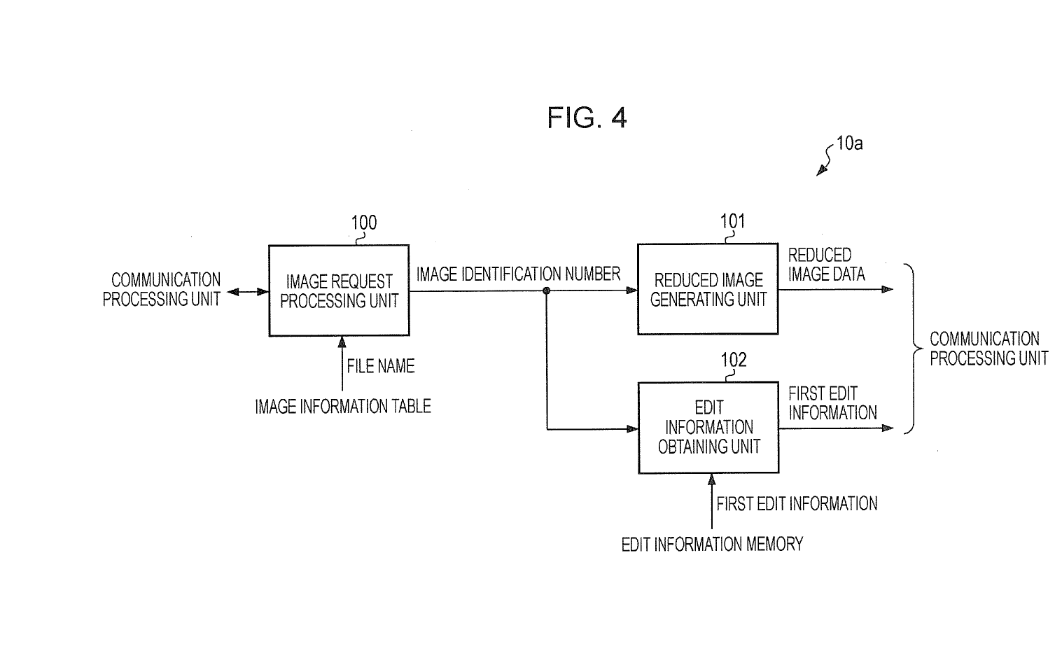

Now, the functions of the CPU 10 of the image forming apparatus 1 will be described in detail. First, the reduced image transmitting unit 10a will be described. As illustrated in FIG. 4, the reduced image transmitting unit 10a includes an image request processing unit 100, a reduced image generating unit 101, and an edit information obtaining unit 102.

The image request processing unit 100 receives an image list request from the terminal apparatus 2 via the communication processing unit 17, and searches the image information table 14a for a target file name in accordance with the user identification number included in the image list request. In the searching, a file name which is associated with a matched user identification number and which is associated with “editable” in “Edit” is selected. For example, in a case where the image information table 14a has the content shown in table 1, assuming that the user identification number included in the image list request is “00001388”, the file names “IMAGE_{—}1108101503”, “IMAGE_{—}1108101615”, and “IMAGE_{—}1108110852” are included in an image list.

Subsequently, the image request processing unit 100 transmits the image list including one or more file names obtained through searching, together with one or more corresponding image identification numbers, to the terminal apparatus 2 via the communication processing unit 17. In the terminal apparatus 2, an image to be edited is selected from the image list.

Upon receiving the image identification number of a selected image from the terminal apparatus 2 via the communication processing unit 17, the image request processing unit 100 notifies the reduced image generating unit 101 and the edit information obtaining unit 102 of the image identification number.

The reduced image generating unit 101 functions as an image reducing unit that reduces image data to generate reduced image data. The reduced image generating unit 101 searches the image data memory 14b for target image data in accordance with the notified image identification number, and reduces the image data. The reduction process may be performed by the image processing unit 150.

A reduced image may be an image obtained by reducing the original size, such as a thumbnail image. The reduction method used by the reduced image generating unit 101 is not limited. The reduction ratio may be constant, or may be determined in accordance with display performance represented by display performance information, which indicates the resolution of a display screen, obtained from the terminal apparatus 2.

Subsequently, the reduced image generating unit 101 transmits the reduced image data obtained from the image processing unit 150 to the terminal apparatus 2 via the communication processing unit 17. At this time, the communication processing unit 17 functions as a transmitting unit that transmits the reduced image data to the external terminal apparatus 2.

On the other hand, the edit information obtaining unit 102 searches the edit information memory 14c for corresponding first edit information in accordance with the notified image identification number. Only in a case where the first edit information exists, the edit information obtaining unit 102 transmits the first edit information to the terminal apparatus 2 via the communication processing unit 17. The case where the first edit information exists may be a case where the corresponding image data has an edit history. Thus, the image data that is to be edited for the first time does not have corresponding first edit information. The terminal apparatus 2 that has received the reduced image data and the first edit information displays and edits the reduced image, and newly generates first edit information.

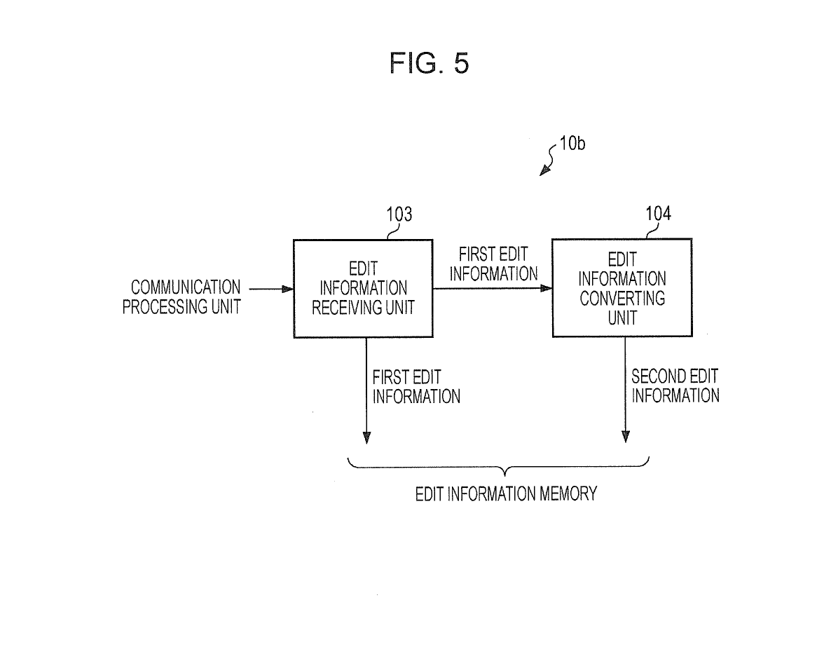

Next, the edit information generating unit 10b will be described. As illustrated in FIG. 5, the edit information generating unit 10b includes an edit information receiving unit 103 and an edit information converting unit 104.

The edit information receiving unit 103 receives, via the communication processing unit 17, first edit information representing the details of edit performed on reduced image data, and stores the first edit information in the edit information memory 14c. At this time, the communication processing unit 17 functions as a receiving unit that receives the first edit information from the terminal apparatus 2. The stored first edit information is regarded as an edit history, and is read out by the edit information obtaining unit 102 when edit is to be newly performed, as described above.

The edit information receiving unit 103 outputs the first edit information to the edit information converting unit 104. The edit information converting unit 104 functions as an edit information converting unit that converts the first edit information to generate second edit information, which represents the details of edit to be performed on image data. The edit information converting unit 104 stores the second edit information obtained through conversion in the edit information memory 14c. The conversion may be performed by converting parameters regarding a position and size included in the first edit information in accordance with the number of pixels of image data, as described below.

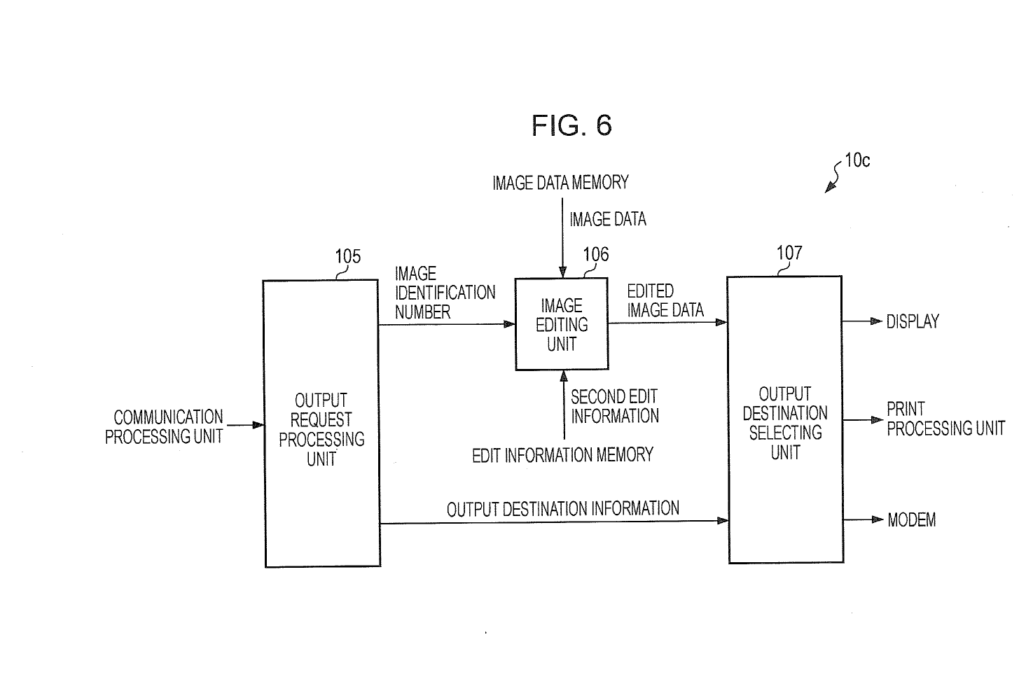

Next, the edited image processing unit 10c will be described. As illustrated in FIG. 6, the edited image processing unit 10c includes an output request processing unit 105, an image editing unit 106, and an output destination selecting unit 107.

The output request processing unit 105 receives an image output request from the terminal apparatus 2 via the communication processing unit 17, notifies the image editing unit 106 of an image identification number included in the image output request, and notifies the output destination selecting unit 107 of output destination information included in the image output request.

The image editing unit 106 functions as an image editing unit that edits image data by using second edit information. The image editing unit 106 outputs edited image data, which is obtained through edit, to the output destination selecting unit 107. The output destination selecting unit 107 outputs the edited image data to the output destination indicated by the notified output destination information among the display 161, the print processing unit 152, and the modem 153.

If the display 161 is selected, the edited image is displayed on the display 161. If the print processing unit 152 is selected, the edited image is printed thereby. If the modem 153 is selected, the edited image is sent by fax. In this case, the output destination information includes address information, and the edited image is sent to the address by fax.

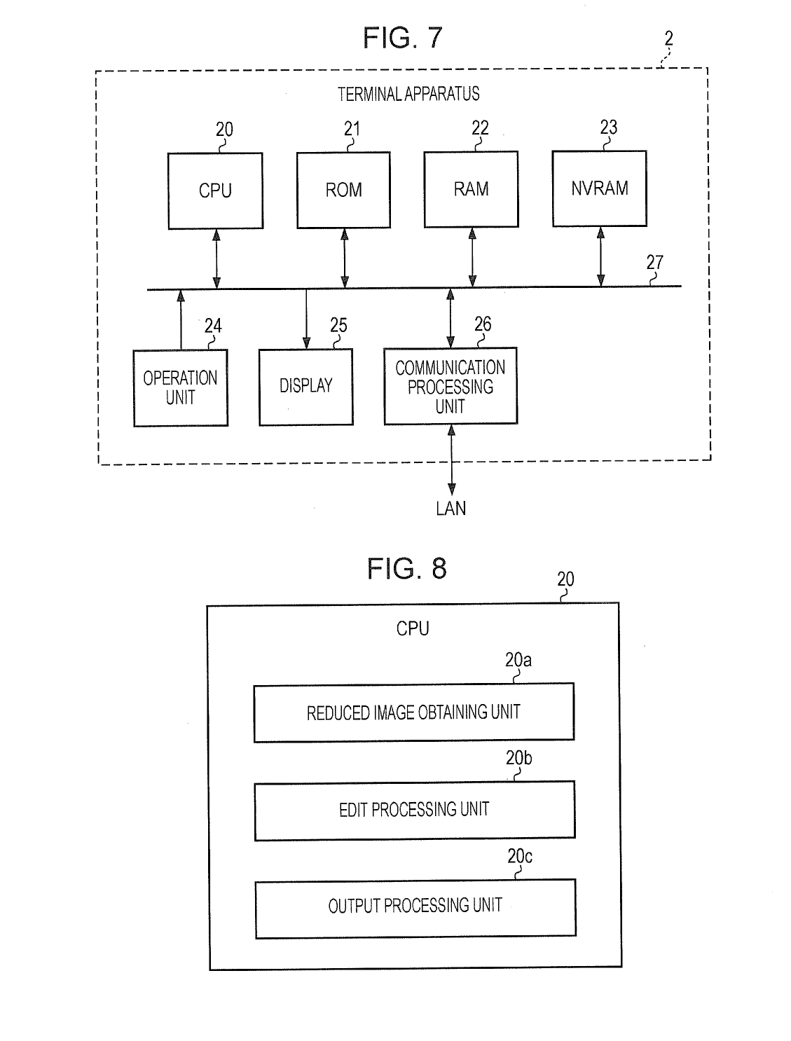

Next, the configuration of the terminal apparatus 2 will be described with reference to FIG. 7. The terminal apparatus 2 includes a CPU 20, a ROM 21, a RAM 22, a nonvolatile memory 23, an operation unit 24, a display 25, and a communication processing unit 26.

The CPU 20 is a processing circuit that controls the entire terminal apparatus 2. The CPU 20 generates first edit information regarding reduced image data and requests output of image data. The ROM 21 stores a program for operating the CPU 20. The RAM 22 is a working memory with which the CPU 20 operates in accordance with the program. The terminal apparatus 2 according to this exemplary embodiment is configured so as to be operated by software, but may be configured by hardware including an ASIC or the like.

The nonvolatile memory 23 is a flash memory, for example, and stores identification information for identifying a user (owner) of the terminal apparatus 2, parameters regarding the operation setting of the apparatus, and so forth.

The operation unit 24 is an operation unit with which a user of the terminal apparatus 2 performs various operations, and includes a touch panel and a hard key. Specifically, the operation unit 24 is used as an operation unit for selecting an image to be edited, editing a reduced image, and selecting an output destination of an image. The display 25 is a liquid crystal panel or the like, and is used together with the foregoing touch panel superimposed on the liquid crystal panel. The display 25 is used as a display unit for displaying an image of reduced image data, an input screen of the touch panel, and so forth.

The communication processing unit 26 is a communication unit that communicates with an external apparatus, is connected to the LAN 40, and includes a circuit for processing communication with another apparatus. The above-described CPU 20, ROM 21, RAM 22, nonvolatile memory 23, operation unit 24, display 25, and communication processing unit 26 are electrically connected to one another via a bus 27. Specifically, the communication processing unit 26 functions as a receiving unit that receives reduced image data from the image forming apparatus 1 and as a transmitting unit that transmits first edit information to the image forming apparatus 1.

Next, the functions of the CPU 20 of the terminal apparatus 2 will be described with reference to FIG. 8. Upon reading a program stored in the ROM 21, the CPU 20 functions as a reduced image obtaining unit 20a, an edit processing unit 20b, and an output processing unit 20c.

The reduced image obtaining unit 20a requests an image list corresponding to the user identification number of the terminal apparatus 2 to the image forming apparatus 1 via the communication processing unit 26, and requests a reduced image of an image selected by using the operation unit 24. The edit processing unit 20b functions as an edit information generating unit that generates first edit information in accordance with an edit operation performed by using the operation unit 24 on the reduced image received from the image forming apparatus 1, and transmits the first edit information to the image forming apparatus 1 via the communication processing unit 26. The output processing unit 20c processes the selection of an output destination of an edited image by the operation unit 24, and provides an instruction to output the edited image to the image forming apparatus 1.

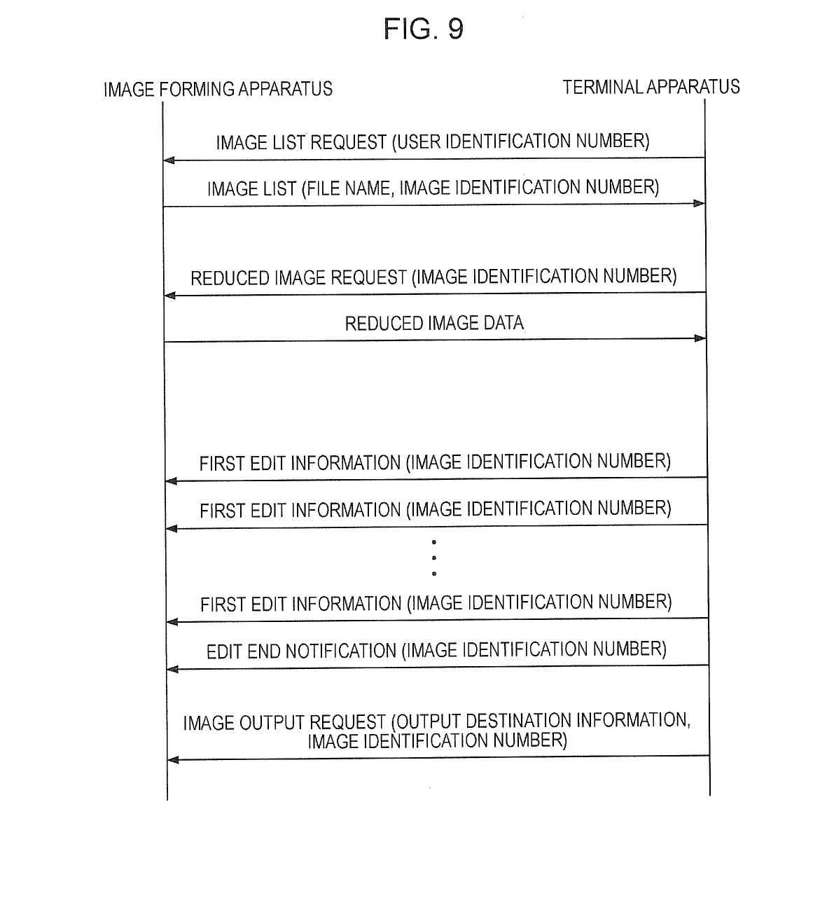

FIG. 9 is a ladder chart illustrating the communication between the image forming apparatus 1 and the terminal apparatus 2. The terminal apparatus 2 transmits an image list request including a user identification number to the image forming apparatus 1. The image forming apparatus 1 receives the image list request, and transmits an image list including a file name and an image identification number corresponding to the user identification number to the terminal apparatus 2.

Subsequently, the terminal apparatus 2 transmits a reduced image request including the image identification number of a selected image to the image forming apparatus 1. The image forming apparatus 1 receives the reduced image request, generates reduced image data corresponding to the image identification number, and transmits the reduced image data to the terminal apparatus 2.

Subsequently, the terminal apparatus 2 generates first edit information in accordance with each edit operation, and transmits the first edit information and the image identification number to the image forming apparatus 1. The image forming apparatus 1 stores the received first edit information in the edit information memory 14c. Upon finishing edit, the terminal apparatus 2 transmits an edit end notification to the image forming apparatus 1.

Subsequently, the terminal apparatus 2 transmits an image output request including output destination information indicating a selected output destination and an image identification number to the image forming apparatus 1. The image forming apparatus 1 receives the image output request, edits the image data corresponding to the image identification number by using second edit information, which has been obtained by converting the first edit information, and outputs the edited image data to the selected output destination.

In the above-described communication, the image forming apparatus 1 and the terminal apparatus 2 may transmit and receive an e-mail in advance to obtain an Internet protocol (IP) address, thereby establishing a link. At the time of establishing a link, the image forming apparatus 1 may transmit a list of edit type codes shown in table 2 to the terminal apparatus 2 so as to determine the edit commands executable by the terminal apparatus 2. An example of a communication scheme used by the image forming apparatus 1 and the terminal apparatus 2 may be a simple object access protocol (SOAP) message based on an extensible markup language (XML).

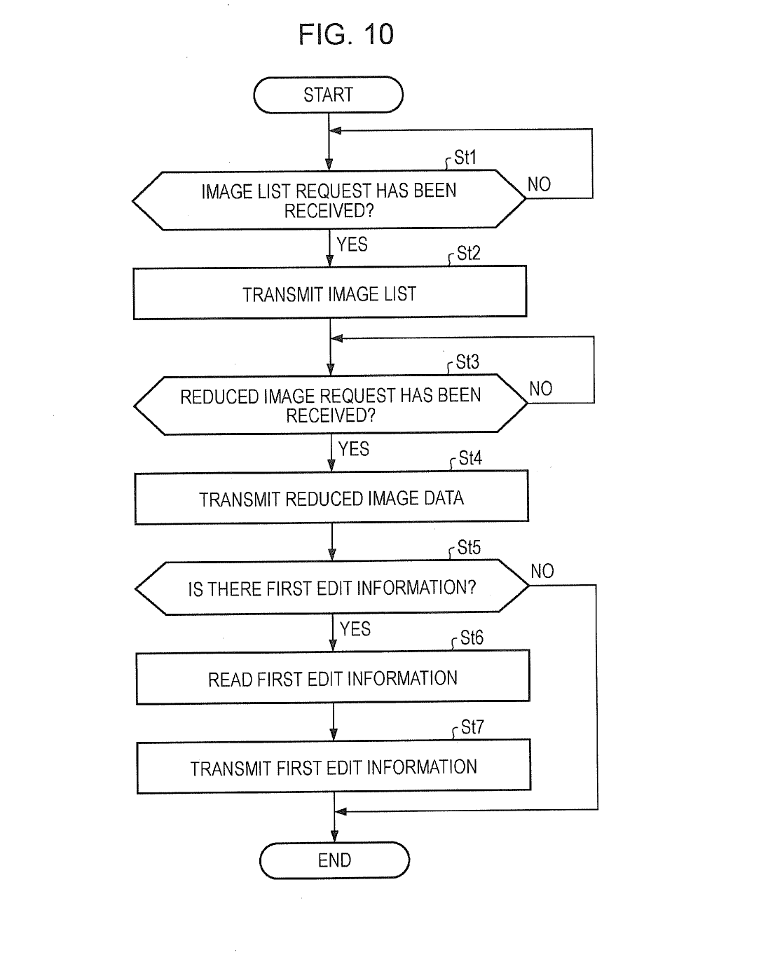

Next, individual processes will be described in detail. FIG. 10 illustrates a process performed by the reduced image transmitting unit 10a. Upon receiving an image list request from the terminal apparatus 2 via the communication processing unit 17 (YES in step St1), the image request processing unit 100 searches the image information table 14a for an image list including a file name and an image identification number corresponding to the user identification number included in the image list request, and transmits the image list to the terminal apparatus 2 (step St2).

Subsequently, upon receiving a reduced image request from the terminal apparatus 2 via the communication processing unit 17 (YES in step St3), the reduced image generating unit 101 generates reduced image data of the corresponding image data, and transmits the reduced image data to the terminal apparatus 2 (step St4).

The edit information obtaining unit 102 searches the image information table 14a. If the corresponding image data has an edit history, that is, if first edit information exists (YES in step St5), the edit information obtaining unit 102 reads out the first edit information from the edit information memory 14c (step St6), and transmits the first edit information to the terminal apparatus 2 via the communication processing unit 17 (step St7). If there is no edit history (NO in step St5), the reduced image transmitting unit 10a ends the process. Note that the order of steps St3 to St4 and steps St5 to St7 is not limited to that illustrated in FIG. 10. These steps may be executed in the reverse order.

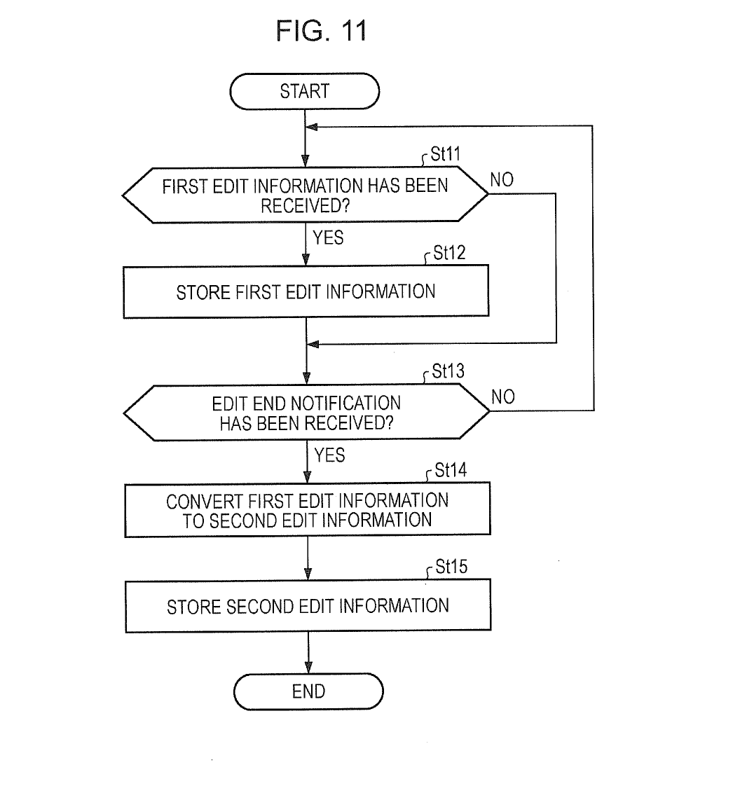

FIG. 11 illustrates a process performed by the edit information generating unit 10b. Upon receiving first edit information from the terminal apparatus 2 via the communication processing unit 17 (YES in step St11), the edit information receiving unit 103 stores the first edit information in the edit information memory 14c (step St12). If the first edit information has not been received (NO in step St11), the process proceeds to step St13, where determination is performed.

Subsequently, upon receiving an edit end notification from the terminal apparatus 2 via the communication processing unit 17 (YES in step St13), the edit information converting unit 104 converts the first edit information to second edit information (step St14), and stores the second edit information in the edit information memory 14c (step St15). If the edit end notification has not been received (NO in step St13), the process returns to step St11. The conversion of the first edit information (step St14) may be performed every time first edit information is received.

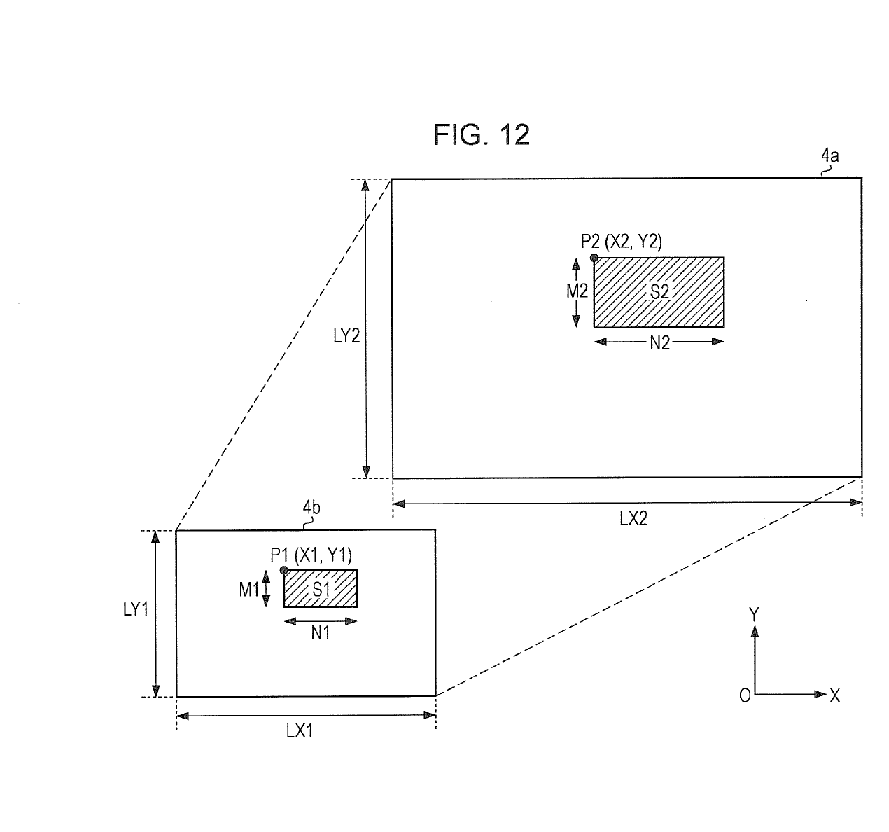

FIG. 12 illustrates a process of converting first edit information performed by the edit information converting unit 104 (step St14). Reference symbol 4a denotes an image of image data generated by the image forming apparatus 1 by using the scan function, and reference symbol 4b denotes a reduced image of the image 4a. Here, it is assumed that the number of pixels of the reduced image 4b is represented by LY1 in the vertical direction×LX1 in the horizontal direction, and that the number of pixels of the image 4a is represented by LY2 in the vertical direction×LX2 in the horizontal direction.

The conversion process is performed on parameters regarding a position and size. First, conversion of position information will be described. P1(X1, Y1) represents first position information (X coordinate, Y coordinate) in the reduced image 4b of reduced image data in a case where the horizontal direction of the reduced image 4b is regarded as an X direction and the vertical direction thereof is regarded as a Y direction. On the other hand, P2(X2, Y2) represents second position information (X coordinate, Y coordinate) in the image 4a of image data in a case where the horizontal direction of the image 4a is regarded as an X direction and the vertical direction thereof is regarded as a Y direction. Here, the origin of the coordinate system is at the lower left corner of the images 4a and 4b in FIG. 12. The first position information P1 and the second position information P2 indicate, for example, the position of “Marking”, the start position and end position of “Straight line”, the position of “Character string”, or the two vertex positions of “Cut out” among the parameters shown in table 2.

The edit information converting unit 104 converts one or more pieces of first position information to one or more pieces of second position information in accordance with the number of pixels LY1 and LX1 of the reduced image data and the number of pixels LY2 and LX2 of the image data. That is, the second position information included in the second edit information may be obtained from the first position information included in the first edit information by using the following equations.

X2=X1×(LX2/LX1) (equation 1)

Y2=Y1×(LY2/LY1) (equation 2)

Next, conversion of size information will be described. The lengths M1 and N1 represent first size information, which corresponds to the vertical and horizontal lengths of a certain region S1 in the reduced image 4b of the reduced image data. On the other hand, the lengths M2 and N2 represent second size information, which corresponds to the vertical and horizontal lengths of a certain region S2 in the image 4a of the image data. The first size information M1 and N1 and the second size information M2 and N2 correspond to the size of “Marking” among the parameters shown in table 2.

The edit information converting unit 104 converts one or more pieces of first size information M1 and N1 to one or more pieces of second size information M2 and N2 in accordance with the number of pixels LY1 and LX1 of the reduced image data and the number of pixels LY2 and LX2 of the image data. That is, the second size information M2 and N2 included in the second edit information may be obtained from the first size information M1 and N2 included in the first edit information by using the following equations.

N2=N1×(LX2/LX1) (equation 3)

M2=M1×(LY2/LY1) (equation 4)

In FIG. 12, the certain regions S1 and S2 are rectangular regions, but the certain regions S1 and S2 may have another shape. For example, if the certain regions S1 and S2 are circular regions, the radius or diameter of the regions may be used as size information, and the major axis and minor axis of an ellipse may be calculated by using the foregoing equations in accordance with the number of pixels LY1 and LX1 of the reduced image data and the number of pixels LY2 and LX2 of the image data.

In FIG. 12, the size of “Marking” among the parameters shown in table 2 is illustrated. Also regarding the thickness of “Straight line” or the size of “Character string”, the thickness of a line or points of characters as size information may be calculated in accordance with the ratio of the number of pixels LY1, LX1, LY2, and LX2.

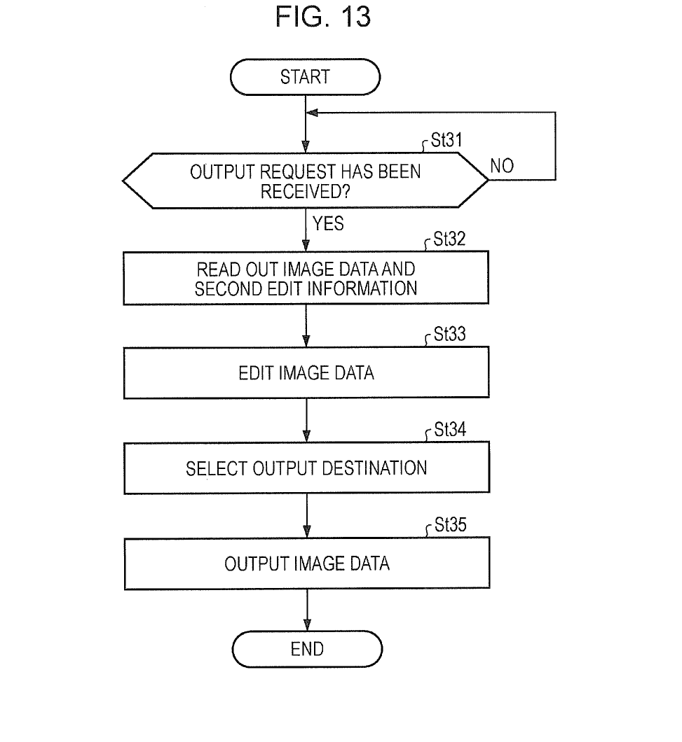

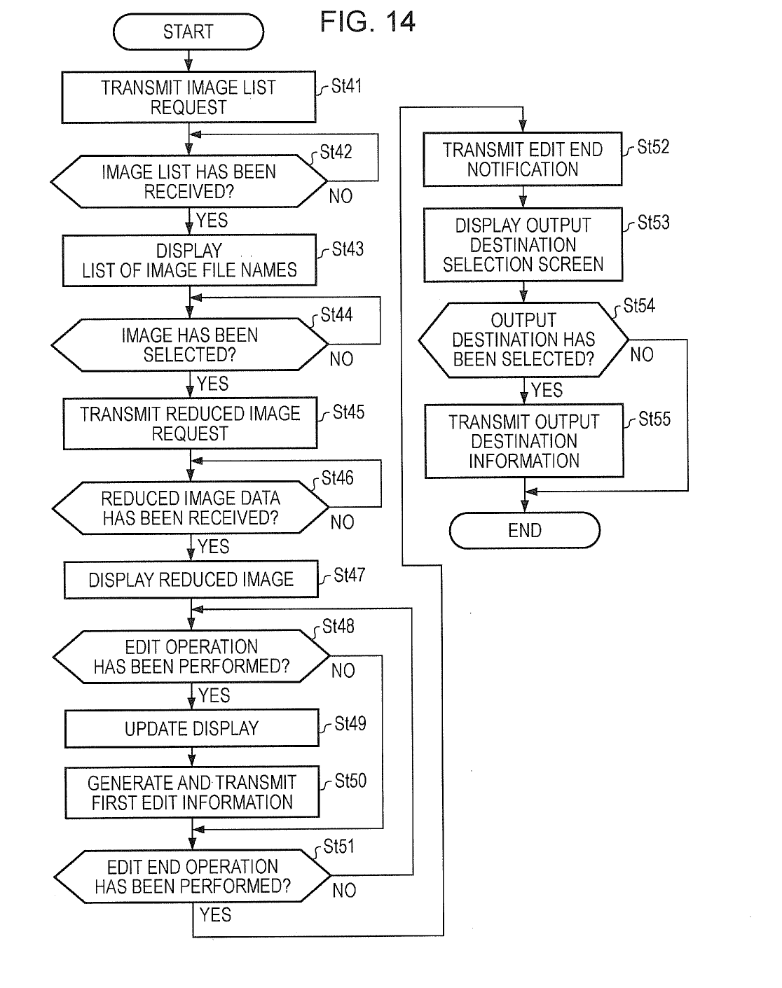

FIG. 13 illustrates a process performed by the edited image processing unit 10c. Upon receiving an output request via the communication processing unit 17 (YES in step St31), the output request processing unit 105 notifies the image editing unit 106 of the image identification number included in the output request, and notifies the output destination selecting unit 107 of the output destination information included in the output request.

The image editing unit 106 reads out the image data corresponding to the image identification number and second edit information from the image data memory 14b and the edit information memory 14c, respectively (step St32), and edits the image data by using the second edit information (step St33). The output destination selecting unit 107 selects an output destination from among the display 161, the print processing unit 152, and the modem 153 in accordance with the output destination information (step St34), and outputs the edited image data to the selected destination (step St35).

Next, a process performed by the CPU 20 of the terminal apparatus 2 will be described with reference to FIG. 14. The reduced image obtaining unit 20a transmits an image list request, together with the user identification number of the user, to the image forming apparatus 1 via the communication processing unit 26 (step St41).

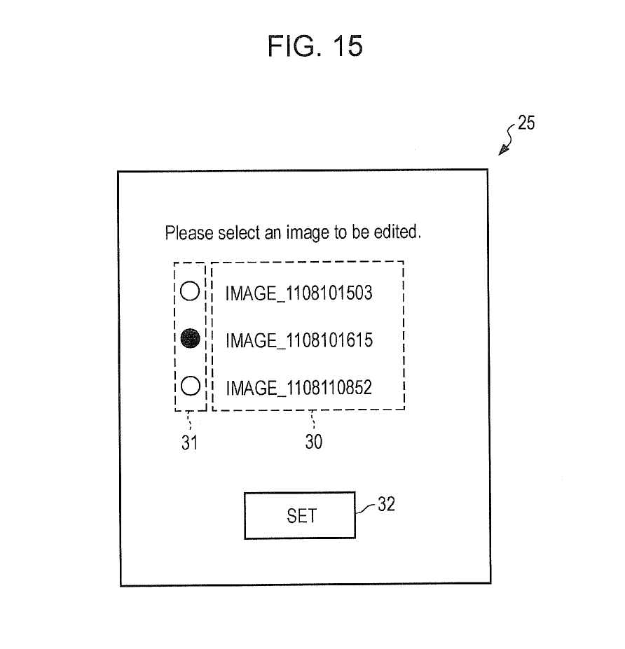

Upon receiving an image list (YES in step St42), the reduced image obtaining unit 20a displays a list 30 of image file names on the display 25, as illustrated in FIG. 15 (step St43). One of the buttons in a region 31 is selected by using the operation unit 24 and then a set button 32 is pressed, thereby an image is selected (YES in step St44).

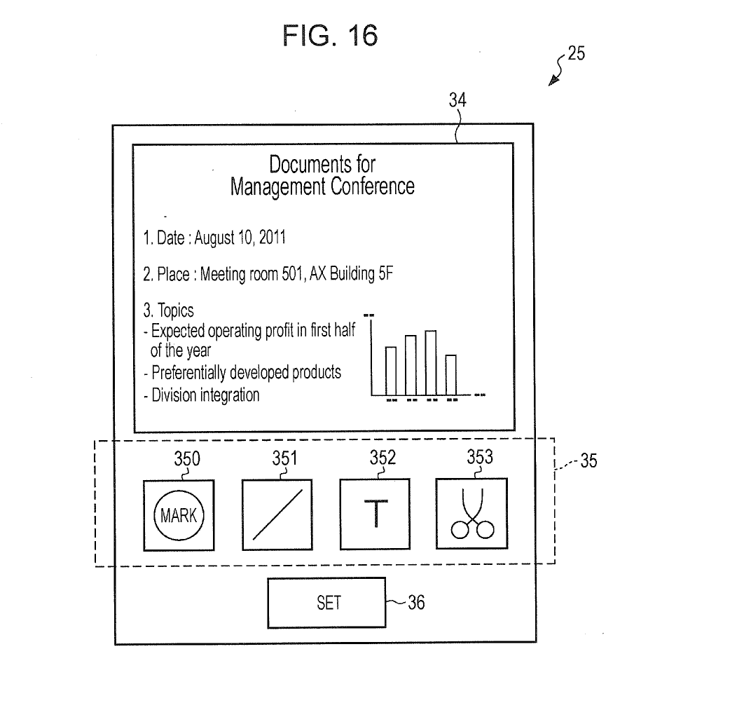

Subsequently, the reduced image obtaining unit 20a transmits a reduced image request including the image identification number of the selected image to the image forming apparatus 1 via the communication processing unit 26 (step St45). Upon receiving reduced image data (YES in step St46), the reduced image obtaining unit 20a displays a reduced image 34 on the display 25, as illustrated in FIG. 16 (step St47). At this time, if the image has an edit history, a reduced image that has been edited using the first edit information received at the same time is displayed. Also, an edit operation unit 35 for editing the reduced image 34 is displayed on the display 25.

The edit operation unit 35 includes edit buttons 350 to 353, which correspond to the edit commands of the edit type codes 001 to 004 shown in table 2, respectively. Upon pressing of one of the edit buttons 350 to 353 with the use of the operation unit 24, the corresponding edit command is executed. Upon pressing of a set button 36 with the use of the operation unit 24, the edit operation is confirmed and completed. The details of the edit operation will be described below.

The edit buttons 350 to 353 may be displayed in accordance with information regarding edit functions received from the image forming apparatus 1 in advance. In this case, for example, the image forming apparatus 1 notifies, via the communication processing unit 17, the terminal apparatus 2 of edit function information representing the details of the edit functions of the image editing unit 106. The notification may be performed anytime before edit is started in the terminal apparatus 2. For example, the notification may be performed at the same time when an image list or reduced image data is transmitted to the terminal apparatus 2, or before or after the transmission.

The edit function information includes the edit type codes 001 to 004 shown in table 2, for example. The terminal apparatus 2 refers to the edit function information, and compares the edit function information with the edit commands included in the edit function of the terminal apparatus 2. As a result of comparison, the terminal apparatus 2 displays the edit buttons 350 to 353 corresponding to the edit commands that match the edit function information. The edit function information may further include a list of parameters associated with the individual edit commands (see “Parameters” in table 2).

As a result of providing such an edit function notifying unit to the image forming apparatus 1, even if the versions of image editing applications (software) installed in the image forming apparatus 1 and the terminal apparatus 2 are different from each other, edit commands available in both the versions may be detected and executed. The image forming apparatus 1 may transmit in advance information regarding edit commands included in the application installed in the image forming apparatus 1, the information serving as data in a batch file format, to the terminal apparatus 2 instead of the edit function information. In this case, the terminal apparatus 2 executes the batch file before editing an image, thereby being able to execute edit commands corresponding to those in the image forming apparatus 1. Thus, the above-described comparison of edit commands is not performed.

Referring back to FIG. 14, upon an edit operation being performed in the edit operation unit 35 (YES in step St48), the edit processing unit 20b updates the display of the reduced image 34 in accordance with the edit operation (step St49). The edit processing unit 20b generates first edit information corresponding to the edit operation, and transmits the first edit information to the image forming apparatus 1 via the communication processing unit 26 (step St50). If no edit operation has been performed (NO in step St48), the process proceeds to step St51, where determination in performed.

Upon an edit end operation being performed through pressing of the set button 36 (YES in step St51), the edit processing unit 20b transmits an edit end notification to the image forming apparatus 1 via the communication processing unit 26 (step St52). If an edit end operation has not been performed (NO in step St51), the process returns to step St48.

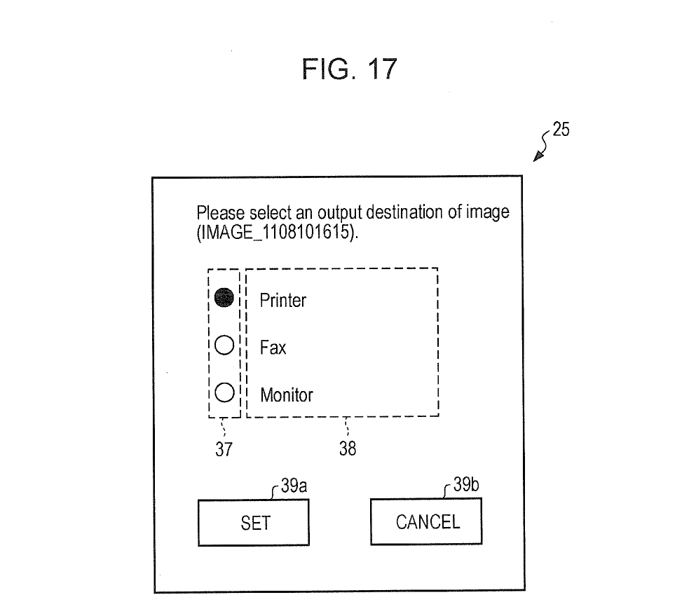

Subsequently, the output processing unit 20c displays an output destination list 38 on the display 25, as illustrated in FIG. 17 (step St53). The output destination list 38 includes printer, facsimile, and monitor. Upon one of the buttons in a region 37 being selected and a set button 39a being pressed with the use of the operation unit 24 (YES in step St54), the output processing unit 20c transmits the output destination information indicating the selected output destination to the image forming apparatus 1 via the communication processing unit 26 (step St55). If facsimile is selected, the above-described address information is input to an input screen, and the address information is transmitted to the image forming apparatus 1 together with the output destination information.

Upon a cancel button 39b being pressed (NO in step St54), the output processing unit 20c determines that an image output process is held, and the process ends. In this case, if the process is restarted from step St41, selecting the same image in step St44 enables the image to be edited and output while reflecting the edit history in the image.

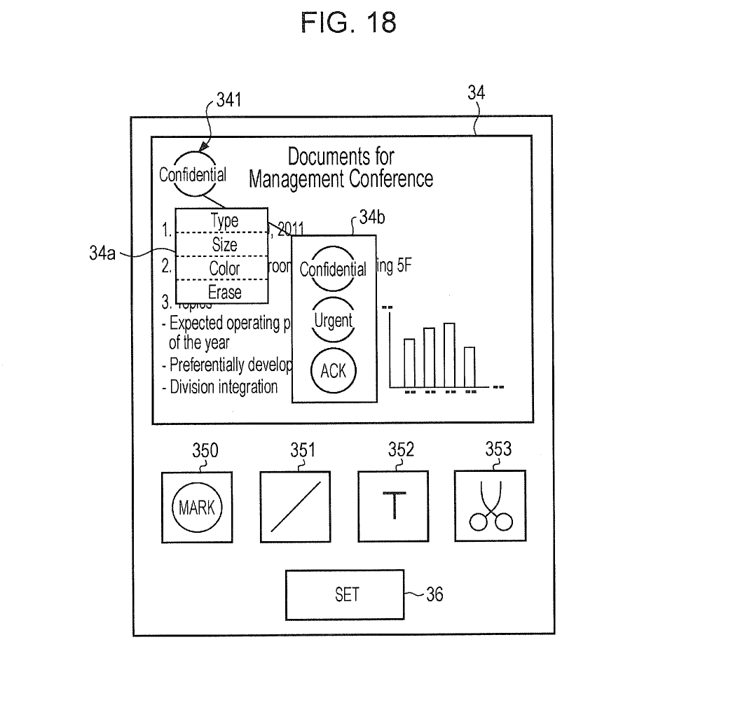

Next, an edit operation will be described. FIG. 18 illustrates a screen in a case where marking is to be performed on the reduced image 34 illustrated in FIG. 16. Pressing of the edit button 350 in a state where a target position of the reduced image 34 is indicated with a pointer causes a mark 341 to be added to the reduced image 34. The setting of the mark 341 is performed by using, for example, a first sub-window 34a and a second sub-window 34b.

The first sub-window 34a is displayed by, for example, double-clicking the mark 341. The first sub-window 34a includes selection items “type”, “size” and “color” corresponding to the parameters shown in table 2, and an item “erase” for erasing the mark 341. The second sub-window 34b is displayed upon “type” being selected from among the items in the first sub-window 34a, and includes three items. Also upon another item being selected from among the items in the first sub-window 34a, items corresponding thereto are displayed on the second sub-window 34b.

As described above, upon any one of the edit buttons 350 to 353 being pressed, displayed items are sequentially selected, and thereby individual parameters corresponding to the specified command are determined. When “erase” is selected in the first sub-window 34a, the first edit information includes information representing “erase” in addition to an edit type code and parameters.

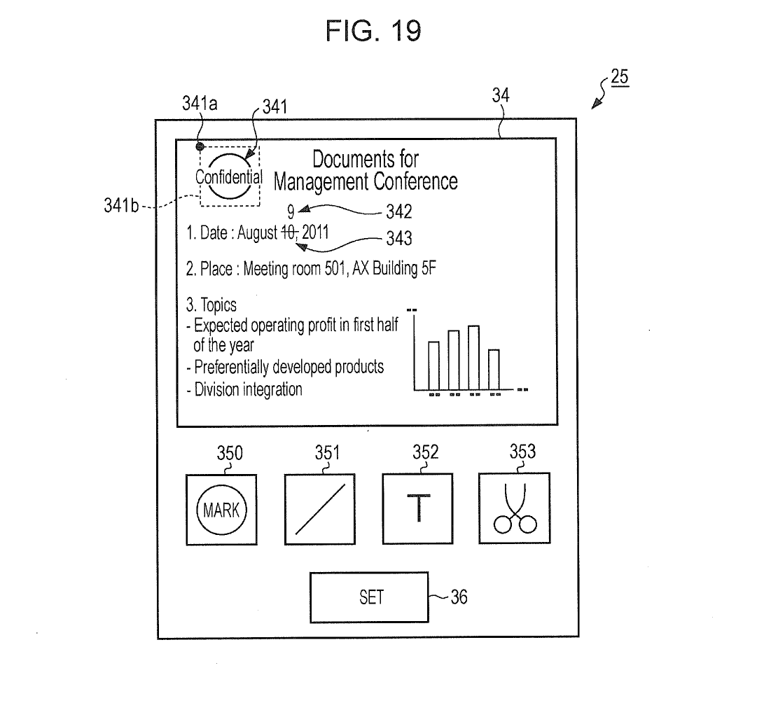

FIG. 19 illustrates an example of editing the reduced image 34. In this example, the mark 341 representing “confidential” is added to the reduced image 34, the date is deleted with a strike-out line 343, and a new date 342 is added. The mark 341 is added by operating the edit button 350, as described above. The strike-out line 343 and the date 342 are added by operating the edit buttons 351 and 352, respectively.

Regarding the mark 341, for example, the first edit information in this edit example includes, as parameters, an upper left position 341a of the mark 341 and the size of a rectangular region 341b including the mark 341. Likewise, regarding the date 342 and the strike-out line 343, information about the head position and size thereof is included in the parameters.

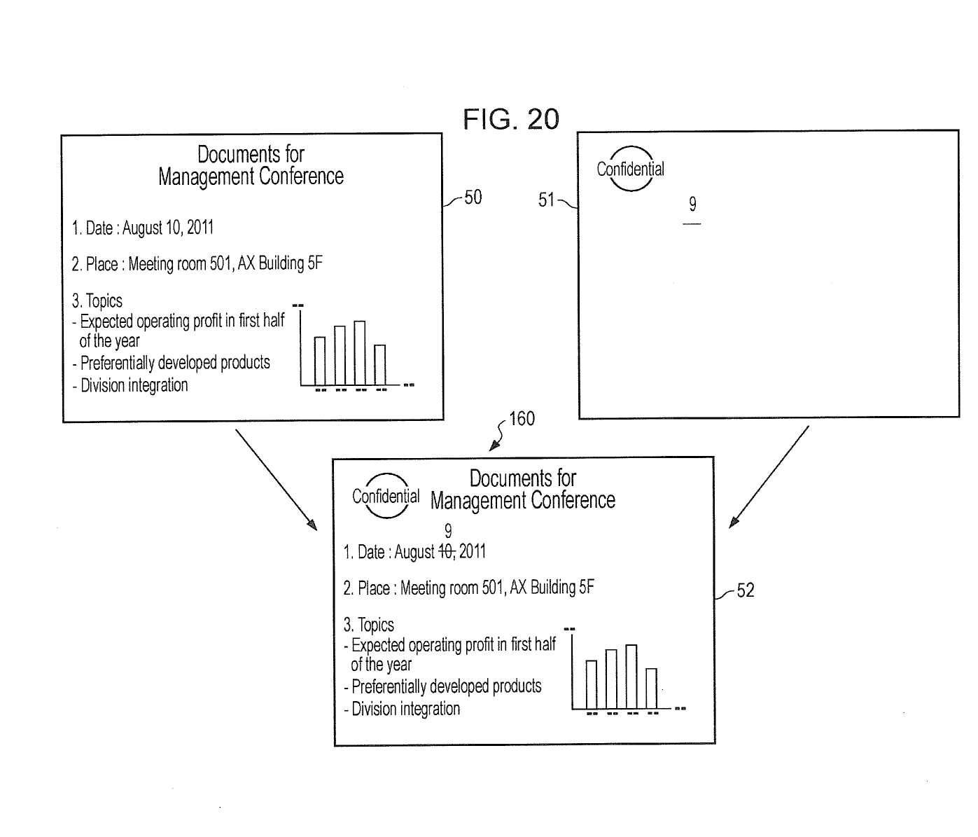

FIG. 20 illustrates an edit process performed by the image editing unit 106 in the edit example illustrated in FIG. 19. In FIG. 20, reference numeral 50 denotes an original image of the reduced image 34, and reference numeral 51 denotes an additional image to be combined with the original image 50, the additional image representing second edit information obtained through conversion performed by the edit information converting unit 104. Reference numeral 52 denotes an edited image obtained by editing the original image 50 by using the second edit information.

As may be understandable from FIG. 20, the image editing unit 106 superimposes the additional image 51 representing the second edit information on the original image 50, thereby obtaining the edited image 52. That is, in the case of editing an image by adding a mark, line, or character string as in this example, the first edit information and second edit information represent additional image information regarding an additional image to be added to a reduced image and an original image. Thus, in this case, the image editing unit 106 combines the image 50 of the image data and the additional image 51 represented by the second edit information, thereby obtaining the edited image 52.

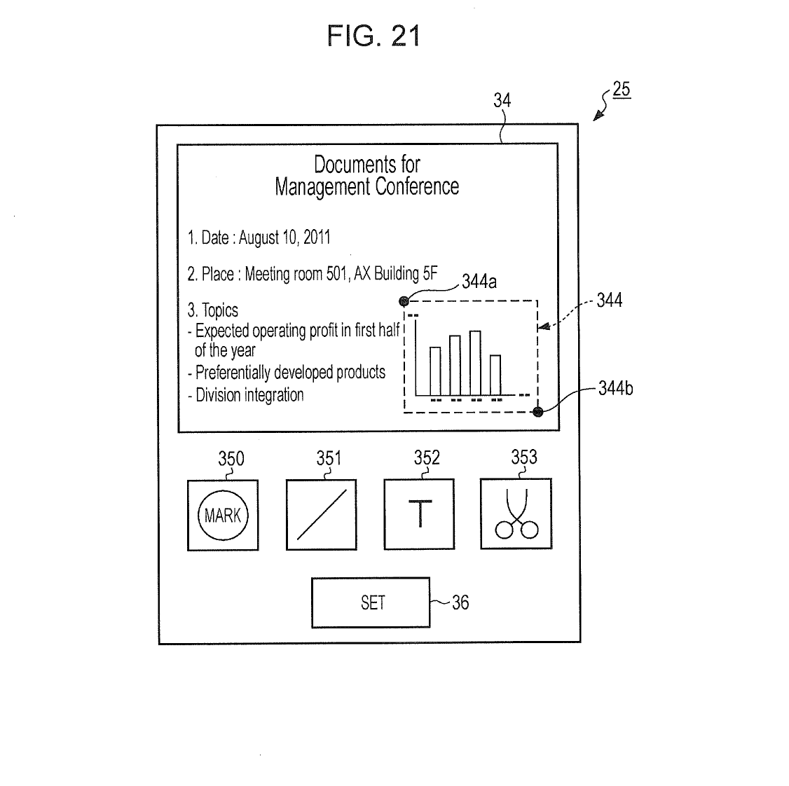

FIG. 21 illustrates another example of editing the reduced image 34. In this example, a bar graph in the reduced image 34 is cut out by using the “Cut out” command. A cut-out region 344 is rectangular and is specified by operating the edit button 353. In this edit example, the first edit information includes, as parameters, two diagonal vertex positions 344a and 344b of the cut-out region 344.

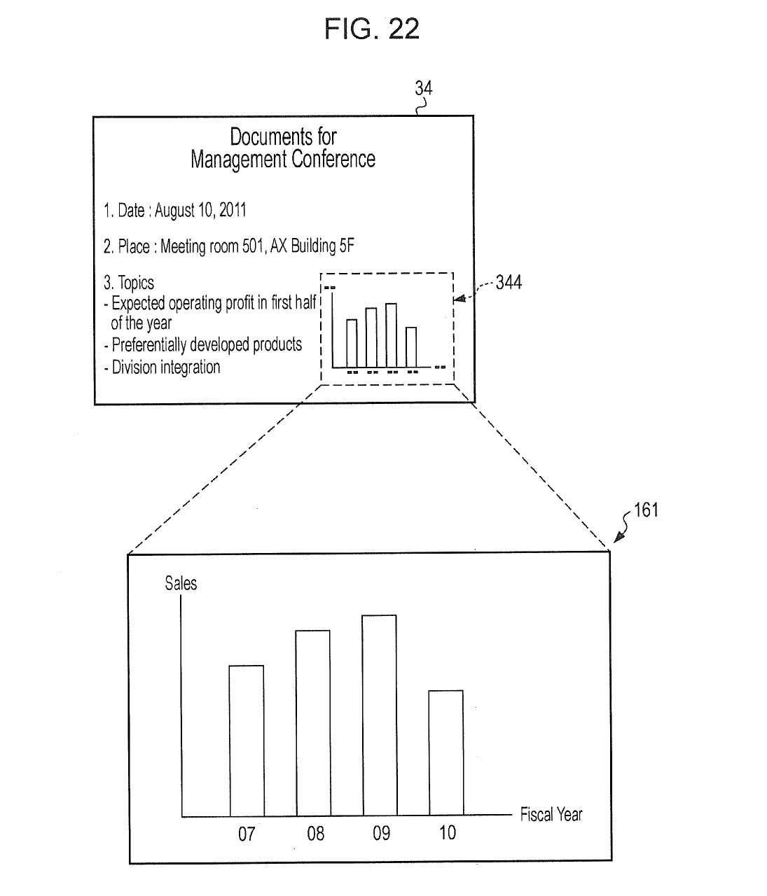

FIG. 22 illustrates a state where an edited image is output to the display 161 of the image forming apparatus 1 in the edit example illustrated in FIG. 21. Here, it is assumed that the display 161 displays the edited image over an entire region of a certain size regardless of the number of pixels of the edited image.

In the case of cutting out a part of an image and displaying the cut out part, as in this example, the cut out part is displayed by being enlarged because the display region has the certain size. Such enlarged display is used to check an image obtained by using the scan function. The method for checking an image is not limited to outputting the image to the display 161. For example, an image may be checked by printing the image by using the print function.

As described above, according to this exemplary embodiment, an image is edited by transmitting and receiving reduced image data and edit information (or additional image information).

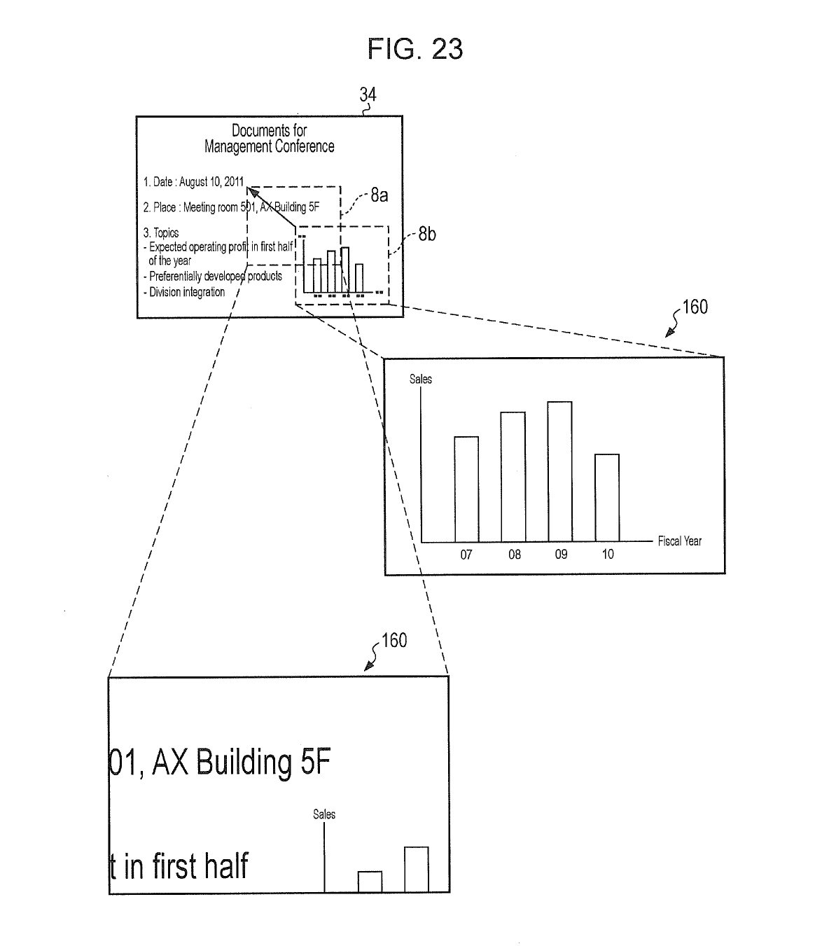

Next, an exemplary embodiment of the case of expanding the above-described function of enlarged display will be described. In this exemplary embodiment, as illustrated in FIG. 23, an enlarged image is displayed on the display 161 of the image forming apparatus 1 in accordance with rectangular frames 8a and 8b which defines regions in the reduced image 34 in the terminal apparatus 2.

In an edit operation according to this exemplary embodiment, only the above-described “Cut out” command is used. Specifically, the frames 8a and 8b are moved by using the operation unit 24. When the positions thereof are determined, the two diagonal vertex positions of each of the frames 8a and 8b are generated as first edit information. The positions of the frames 8a and 8b may be determined when a user moves his/her finger off a touch panel, if the operation unit 24 is a touch panel.

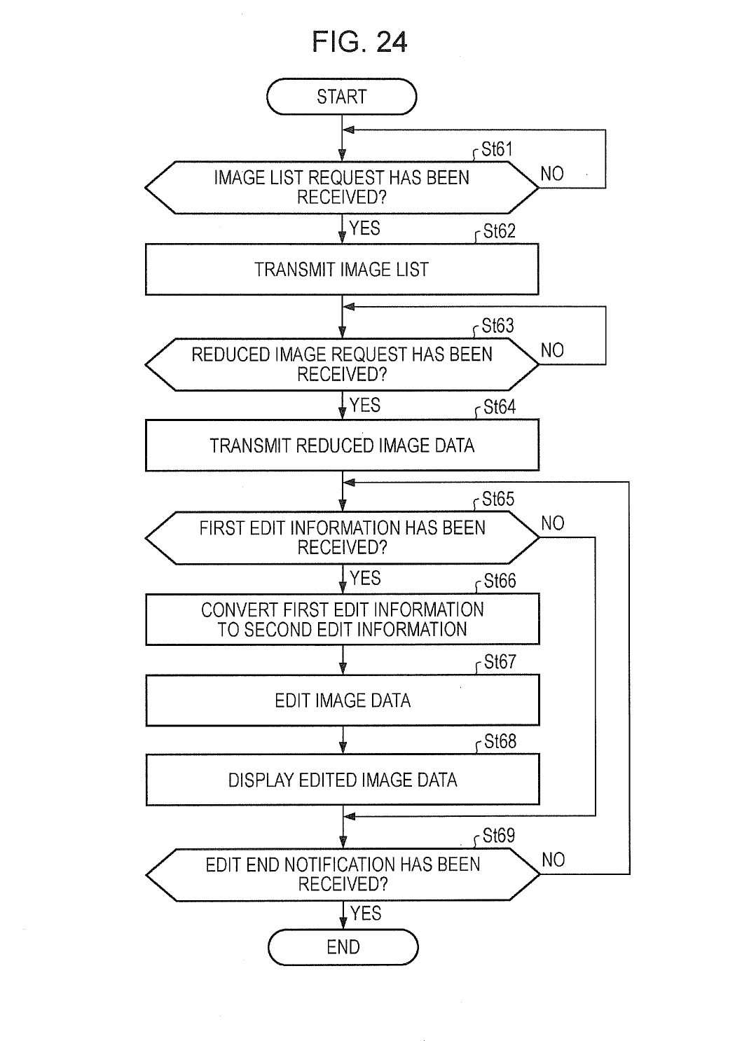

FIG. 24 illustrates a process performed by the CPU 10 of the image forming apparatus 1 according to this exemplary embodiment. Here, steps St61 to St64 are similar to steps St1 to St4 in FIG. 10, and thus the description thereof will be omitted.

Upon receiving first edit information (YES in step St65), the CPU 10 converts the first edit information to second edit information (step St66). The conversion is performed by, as described above with reference to FIG. 12, converting the position P1 in the reduced image 4b to the position P2 in the original image 4a for the two diagonal vertex positions of the frames 8a and 8b.

Subsequently, the CPU 10 edits the image data by using the second edit information (step St67). Specifically, the CPU 10 cuts out the regions defined by the frames 8a and 8b from the image of the image data. The cut out regions correspond to edited images.

Subsequently, the CPU 10 displays edited images obtained through an edit process on the display 161 (step St68). The images displayed here are regions in the frames 8a and 8b which are enlarged, as illustrated in FIG. 23. This exemplary embodiment is directed to realizing the function of enlarged display, and thus selection of an output destination is not performed unlike in the preceding exemplary embodiment.

Subsequently, upon receiving an edit end notification from the terminal apparatus 2 via the communication processing unit 17 (YES in step St69), the CPU 10 ends the process. If the edit end notification has not been received (NO in step St69), the process returns to step St65.

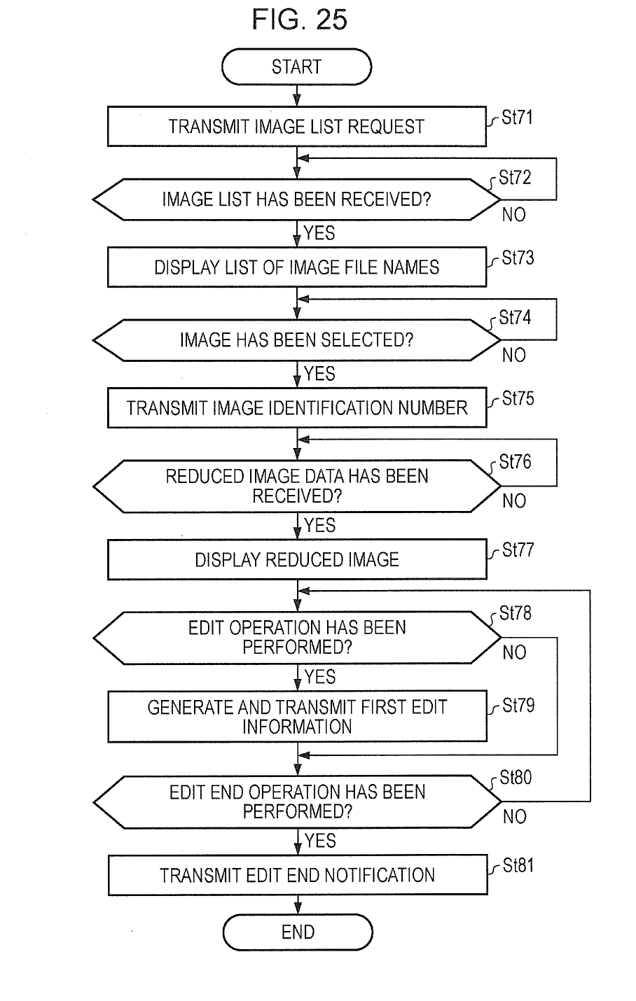

FIG. 25 illustrates a process performed by the CPU 20 of the terminal apparatus 2. Here, steps St71 to St77 are similar to steps St41 to St47 in FIG. 14, and thus the description thereof will be omitted.

The CPU 20 determines whether or not an edit operation has been performed (step St78). Specifically, the CPU 20 determines that an edit operation has been performed when the positions of the frames 8a and 8b are determined (YES in step St78). Subsequently, the CPU 20 generates first edit information in accordance with the vertex positions of the frames 8a and 8b, and transmits the first edit information to the image forming apparatus 1 via the communication processing unit 26 (step St79). On the other hand, if an edit operation has not been performed (NO in step St78), the process proceeds to step St80, where determination is performed.

Subsequently, the CPU 20 determines whether or not an edit end operation has been performed (step St80). Specifically, the CPU 20 determines that an edit end operation has been performed upon the set button 36 illustrated in FIG. 16 being pressed (YES in step St80). Subsequently, the CPU 20 transmits an edit end notification to the image forming apparatus 1 via the communication processing unit 26 (step St81). If an edit end operation has not been performed (NO in step St80), the process returns to step St78.

According to this exemplary embodiment, the frames 8a and 8b are operated on the display 25 of the terminal apparatus 2, and thereby certain regions of an image are displayed in an increased size on the display 161 of the image forming apparatus 1.

In the above-described exemplary embodiments, a process of converting first edit information to second edit information is performed by the image forming apparatus 1. Alternatively, the conversion process may be performed by the terminal apparatus 2. Hereinafter, an exemplary embodiment of this case will be described.

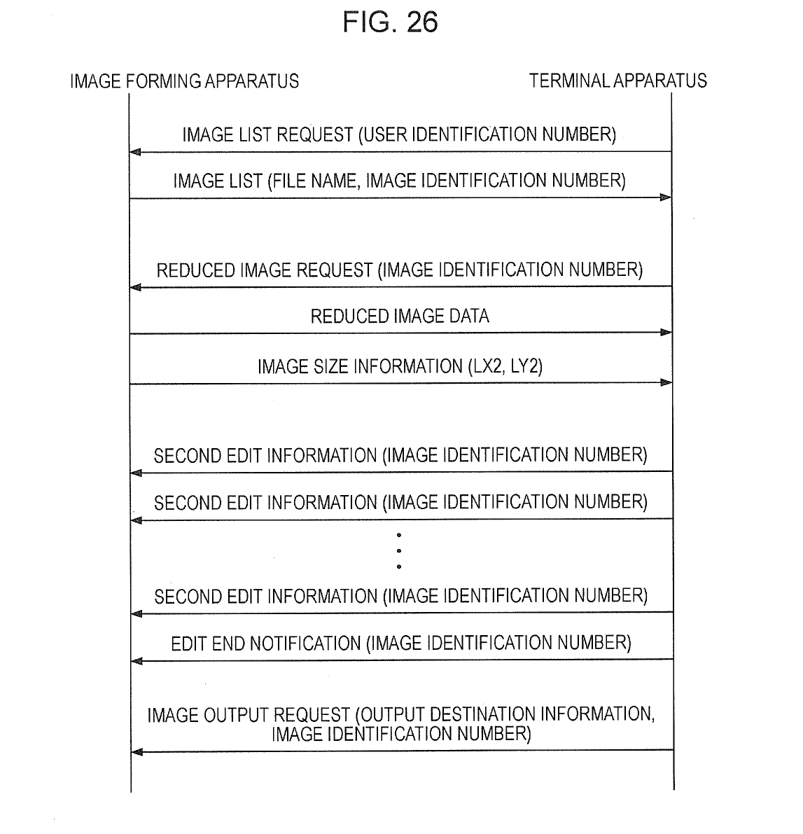

FIG. 26 is a ladder chart corresponding to the ladder chart illustrated in FIG. 9. As may be understood from FIG. 26, the image forming apparatus 1 transmits image size information (LX2, LY2) about original image data to the terminal apparatus 2, unlike in the above-described exemplary embodiments. On the other hand, the terminal apparatus 2 converts first edit information to second edit information in accordance with the received image size information and transmits the second edit information to the image forming apparatus 1.

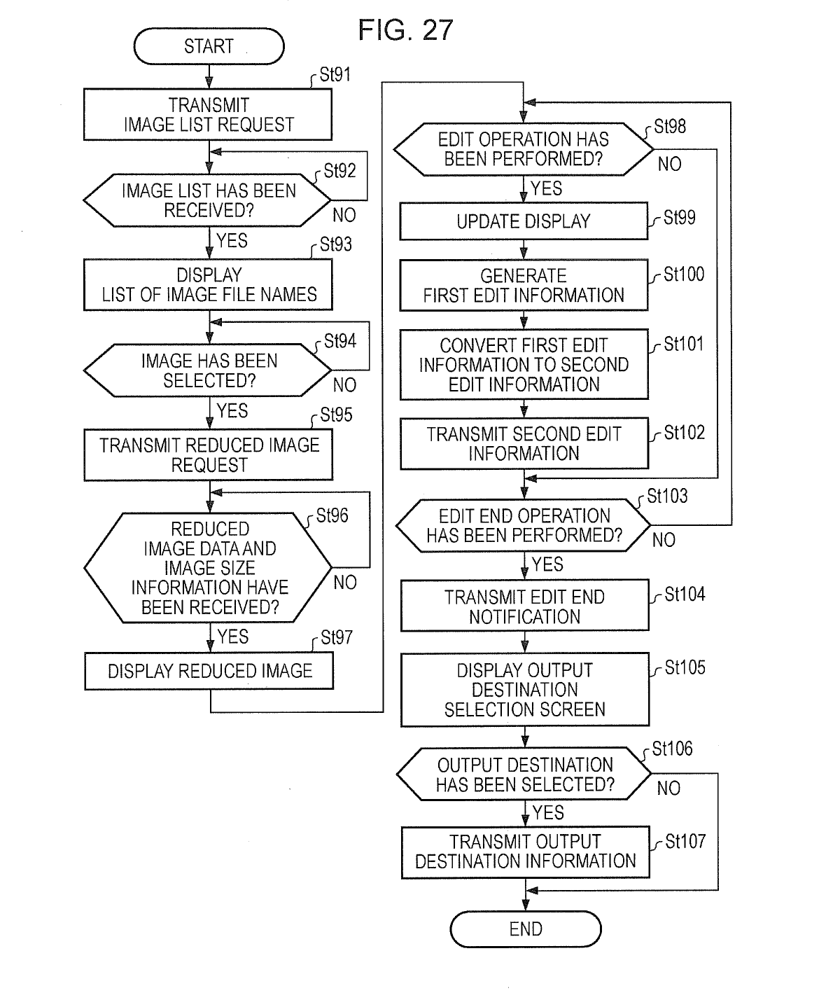

Next, a process performed by the CPU 20 of the terminal apparatus 2 will be described with reference to FIG. 27. Here, steps St91 to St95, St97 to St100, and St103 to St107 are similar to steps St41 to St45, St47 to St50, and St53 to St57 in FIG. 14, respectively, and thus the description thereof will be omitted.

In step St96, the reduced image obtaining unit 20a waits until receiving reduced image data and image size information from the image forming apparatus 1. Upon receiving reduced image data and image size information (YES in step St96), the reduced image obtaining unit 20a displays a reduced image on the display 25 (step St97).

Subsequently, the edit processing unit 20b generates first edit information in accordance with an operation performed in the edit operation unit 35, as described above with reference to FIG. 16 (step St100), and converts the first edit information to second edit information in accordance with the image size information (step St101). The conversion is performed in the manner described above with reference to FIG. 12. Subsequently, the edit processing unit 20b transmits the second edit information to the image forming apparatus 1 via the communication processing unit 26 (step St102).

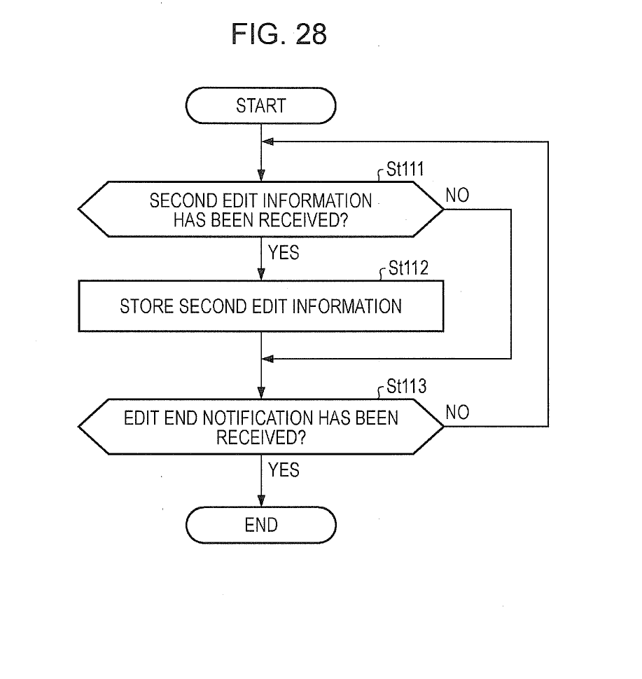

FIG. 28 illustrates a process performed by the edit information generating unit 10b in the CPU 10 of the image forming apparatus 1. Upon receiving the second edit information from the terminal apparatus 2 via the communication processing unit 17 (YES in step St111), the edit information generating unit 10b stores the second edit information in the edit information memory 14c of the HDD 14 (step St112). Subsequently, upon receiving an edit end notification from the terminal apparatus 2 via the communication processing unit 17 (YES in step St113), the edit information generating unit 10b ends the process. Otherwise (NO in step St113), the process returns to step St111. The same applies to a case where the second edit information has not been received (NO in step St111).

In this exemplary embodiment, the image forming apparatus 1 stores second edit information, which is edit history information, in the edit information memory 14c of the HDD 14. Thus, when there is second edit information, the image forming apparatus 1 transmits the second edit information as edit history information to the terminal apparatus 2 together with a reduced image, in response to a request for the reduced image from the terminal apparatus 2. The terminal apparatus 2 receives the second edit information, converts it to first edit information, reflects the first edit information in the reduced image, and displays the reduced image.

In the above-described exemplary embodiments, the image forming apparatus 1 allows the terminal apparatus 2 to edit image data obtained through scanning. The same process may be performed on other image data. For example, the image forming apparatus 1 may allow the terminal apparatus 2 to edit facsimile image data received via the modem 153.

In the above-described exemplary embodiments, the image forming apparatus 1 transmits reduced image data, which is obtained by reducing image data, to the terminal apparatus 2. The form of data to be transmitted is not limited, and any form may be acceptable as long as the data is related to the image data. For example, the image forming apparatus 1 may extract data in a specific region to be edited from image data, and transmit the extracted data to the terminal apparatus 2.

The operation and effect similar to those of the above-described exemplary embodiments may also be obtained by providing an image forming apparatus or terminal apparatus with a recording medium containing a program for realizing the above-described functions and by causing a computer in the apparatus to execute the program. Any type of computer readable recording medium may be used, for example, a compact disc-read only memory (CD-ROM), a digital versatile disc (DVD), or a secure digital (SD) card.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image data memory that stores image data;
a transmitting unit that transmits related image data related to the image data to an external terminal apparatus;
a receiving unit that receives first edit information from the external terminal apparatus, the first edit information representing details of edit that has been performed on the related image data;
an edit information converting unit that converts the first edit information to generate second edit information, the second edit information representing details of edit that is to be performed on the image data; and
an image editing unit that edits the image data by using the second edit information.

2. The image forming apparatus according to claim 1,
wherein the first edit information corresponds to one or more pieces of first additional image information representing details of an additional image that is to be added to an image of the related image data,
wherein the second edit information corresponds to one or more pieces of second additional image information representing details of an additional image that is to be added to an image of the image data, and
wherein the image editing unit combines the image of the image data and an additional image represented by the second additional image information.

3. The image forming apparatus according to claim 1,
wherein the first edit information includes one or more pieces of first position information indicating a position in an image of the related image data,
wherein the second edit information includes one or more pieces of second position information indicating a position in an image of the image data, and
wherein the edit information converting unit converts the one or more pieces of first position information to the one or more pieces of second position information in accordance with the number of pixels of the related image data and the number of pixels of the image data.

4. The image forming apparatus according to claim 1,
wherein the first edit information includes one or more pieces of first size information indicating a size of a certain region in an image of the related image data,
wherein the second edit information includes one or more pieces of second size information indicating a size of a certain region in an image of the image data, and
wherein the edit information converting unit converts the one or more pieces of first size information to the one or more pieces of second size information in accordance with the number of pixels of the related image data and the number of pixels of the image data.

5. The image forming apparatus according to claim 1, further comprising:
an edit function notification unit that notifies the external terminal apparatus of edit function information representing details of an edit function of the image editing unit.

6. An image forming system comprising:
the image forming apparatus according to claim 1; and
a terminal apparatus including
a terminal-apparatus-side receiving unit that receives the related image data from the image forming apparatus,
a display that displays an image of the related image data,
an operation unit that receives an operation for editing the image of the related image data,
an edit information generating unit that generates the first edit information in accordance with the operation, and
a terminal-apparatus-side transmitting unit that transmits the first edit information to the image forming apparatus.

7. A non-transitory computer readable medium storing a program causing a computer to execute a process for forming an image, the process comprising:
storing image data;
transmitting related image data related to the image data to an external terminal apparatus;
receiving first edit information from the external terminal apparatus, the first edit information representing details of edit that has been performed on the related image data;
converting the first edit information to generate second edit information, the second edit information representing details of edit that is to be performed on the image data; and
editing the image data by using the second edit information.

8. The non-transitory computer readable medium according to claim 7,
wherein the first edit information corresponds to one or more pieces of first additional image information representing details of an additional image that is to be added to an image of the related image data,
wherein the second edit information corresponds to one or more pieces of second additional image information representing details of an additional image that is to be added to an image of the image data, and
wherein the editing combines the image of the image data and an additional image represented by the second additional image information.

9. The non-transitory computer readable medium according to claim 7,
wherein the first edit information includes one or more pieces of first position information indicating a position in an image of the related image data,
wherein the second edit information includes one or more pieces of second position information indicating a position in an image of the image data, and
wherein the converting converts the one or more pieces of first position information to the one or more pieces of second position information in accordance with the number of pixels of the related image data and the number of pixels of the image data.

10. The non-transitory computer readable medium according to claim 7,
wherein the first edit information includes one or more pieces of first size information indicating a size of a certain region in an image of the related image data,
wherein the second edit information includes one or more pieces of second size information indicating a size of a certain region in an image of the image data, and
wherein the converting converts the one or more pieces of first size information to the one or more pieces of second size information in accordance with the number of pixels of the related image data and the number of pixels of the image data.

11. The non-transitory computer readable medium according to claim 7, the process further comprising:
notifying the external terminal apparatus of edit function information representing details of an edit function of the editing.

12. A non-transitory computer readable medium storing a program causing a computer to execute a process, the process comprising:
receiving, from an image forming apparatus, related image data related to image data stored in the image forming apparatus;
displaying an image of the related image data;
receiving an operation for editing the image of the related image data;
generating first edit information in accordance with the operation, the first edit information representing details of edit that has been performed on the related image data; and
transmitting the first edit information to the image forming apparatus.

13. A non-transitory computer readable medium storing a program causing a computer to execute a process, the process comprising:
receiving, from an image forming apparatus, related image data related to image data stored in the image forming apparatus;
displaying an image of the related image data;
receiving an operation for editing the image of the related image data;
generating first edit information in accordance with the operation, the first edit information representing details of edit that has been performed on the related image data;
converting the first edit information to generate second edit information, the second edit information representing details of edit that is to be performed on the image data; and
transmitting the second edit information to the image forming apparatus.
